(19) United States
(12) Patent Application Publication
(10) Pub. No.: US 2009/0288717 A1
(43) Pub. Date: Nov. 26, 2009

(54) BASEMENT SECURITY BUCKET

(76) Inventor: Brett Allan Lenox, Ottawa, IL (US)

Correspondence Address: LAWRENCE E. LAMBELET JR., 5 BLACKWELL ROAD, FLEMINGTON, NJ, 08822, US

(21) Appl. No.: 12/468,956

(22) Filed: May 20, 2009

Related U.S. Application Data
(60) Provisional application No. 61/055,122, filed on May 21, 2008.

(51) Int. Cl. F16L 5/00; E03B 7/07

(52) U.S. Cl. 137/362; 137/558

(57) ABSTRACT

The present invention provides an open-topped flood-prevention sump well extension. A cylindrical wall placed around a sump pit extends above the floor level to the proximity of a sewer or septic drain. A connecting pipe automatically drains the overflow attendant to a malfunctioning or overloaded sump pump to the sewer or septic system. A means for preventing backflow of sewer discharge is provided by a one-way valve or a plumbing trap. An alarm system is provided for signaling rising water level.

### CROSS-REFERENCE TO RELATED APPLICATIONS

Priority is claimed to Provisional Application 61/055,122, filed May 21, 2008

### BACKGROUND OF THE INVENTION

1. Field of the Invention

The field of the present invention is plumbing. More specifically, the field relates to sump well overflow control.

2. Description of Related Art

Basement flooding is a major concern of property owners, especially those living in low-lying areas, such as flood plains. It is common, therefore, to build a sump well with a pump into the basement for the purpose of pumping out water before it can flood the basement.

Commonly, the sump and sump pump assembly consists of a pit extending below the floor level of the basement and a submersible pump that pumps water out of the pit as it collects.

The current systems work in most situations. A problem still exists, however, if a sump pump fails, or if a rising water table overwhelms the capacity of the pump. The sump well becomes an entry point for flood water which inundates the basement and causes damage to any finishing or storage therein, not to mention humidity-soaking the whole house.

A number of attempts have been made to alleviate such a problem. By way of example, U.S. Pat. No. 5,007,451 to Bralich provides a cylindrical enclosure effectively raising the height of the sump. In addition, Bralich provides a conduit from the cylindrical enclosure to a floor level drain. Bralich, however, does not provide drainage to a sewer system above floor level and does not provide backflow protection for sewer gas. In addition, Bralich does not have an alarm for alerting the homeowner to a rising level of water.

U.S. Pat. No. 4,553,561 to Morris shows a closed retaining cylinder which drains to plumbing leading to a sewer or septic system through a valve. Because Morris's system is closed with a cap, however, it does not allow viewing of the sump well and pump, which would otherwise make the sump well and pump easier to inspect and service. In addition, Morris does not provide an alarm for alerting the homeowner in case of rising water. Furthermore, Morris does not have a means for prevent backflow from the sewer or septic system other than by closing a manual valve. If the valve is maintained in a closed position, however, the capped cylinder becomes a pressure vessel requiring increased costs for installation, and attendance by a person is required to open the valve to drain the seepage.

U.S. Published Application 2005/0034383 by Allen provides a cylindrical enclosure effectively enclosing and raising the height of the sump. While Allen provides an alarm to notify a person when the water has risen past a certain point, the system does not to drain the enclosure; rather, the water within rises and falls with the environmental water table. Because there is, effectively, no height limitation, strain is placed on the seals and monitoring would be required for complete confidence. In other words, the system is not self-correcting in the extreme.

What is needed is an improved device for retaining water to a point higher than the basement floor level, where sewer drains are typically located, should the sump pump fail. Such an improved device would automatically drain overflows without homeowner intervention, and would include a check valve to ensure one-way flow to the drain system. The improved device should be economical to install and should provide easy access for inspection and maintenance of the sump pump. In addition, the improved device should provide an alarm to notify a property owner of a sump pump failure.

### BRIEF SUMMARY OF THE INVENTION

In view of the above-mentioned unfulfilled needs in the prior art, the present invention embodies the objects and advantages detailed herein:

A first object of the present invention is to provide a flood prevention system which prevents a basement from flooding when the pump equipment malfunctions, or when the capacity is insufficient for the inflow.

A second object of the present invention is to provide a flood prevention system which is easy to install, durable and inexpensive to manufacture.

A third object of the present invention is to provide a flood prevention system that is simple to maintain and to inspect by a homeowner.

A fourth object of the present invention is to provide a flood prevention system that will alert the homeowner as to malfunctioning pump equipment.

A fifth object of the present invention is to provide a flood prevention system that prevents backflow of sewage gases and raw sewage from a sewer or septic drain.

The preferred embodiment of the present invention provides an open-topped flood-prevention sump well extension. The device comprises a cylindrical wall effectively extending the sump sidewall from the floor level to above the level of a sewer or septic drain. An opening in the cylindrical wall is used for receiving a pipe. This pipe extends from the opening to the sewer or septic drain, whereby the drain is rendered in fluid communication with the sump. If no part of the pipe is above the distal rim of the cylindrical wall, rising water within will gravity drain to the sewer or septic system. A one-way valve is provided for preventing raw sewage and sewer gases from backing through the sewer or septic drain and into the sump pit. Finally, a sensor/alarm system is provided for detecting rising water and alerting the homeowner. In a second embodiment, the one-way valve is replaced with a trap. In this embodiment, the trap is of the U-shaped type which maintains a constant pool of water. The standing water occludes the pipe opening and prevents sewer gas from escaping.

### BRIEF DESCRIPTION OF THE SEVERAL VIEWS OF THE DRAWING(S)

Various other objects, features and attendant advantages of the present invention will become fully appreciated through consideration of the accompanying drawings and the detailed description following, in which like reference characters designate the same or similar parts throughout the several views, and wherein:

FIG. 1a is a front perspective view of the preferred embodiment of the present invention; and

FIG. 1b is a front perspective view of a second embodiment of the present invention.

### DETAILED DESCRIPTION OF THE INVENTION

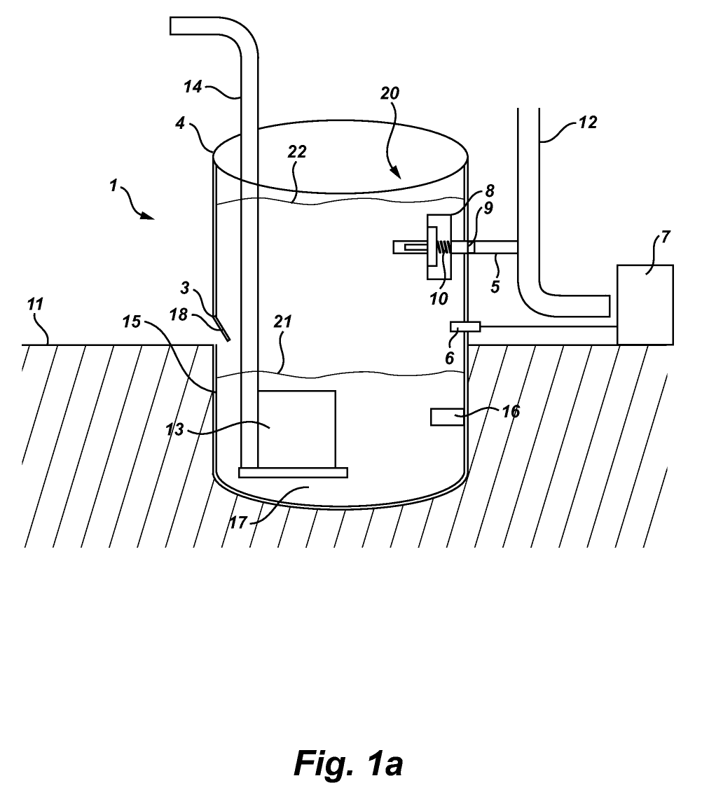

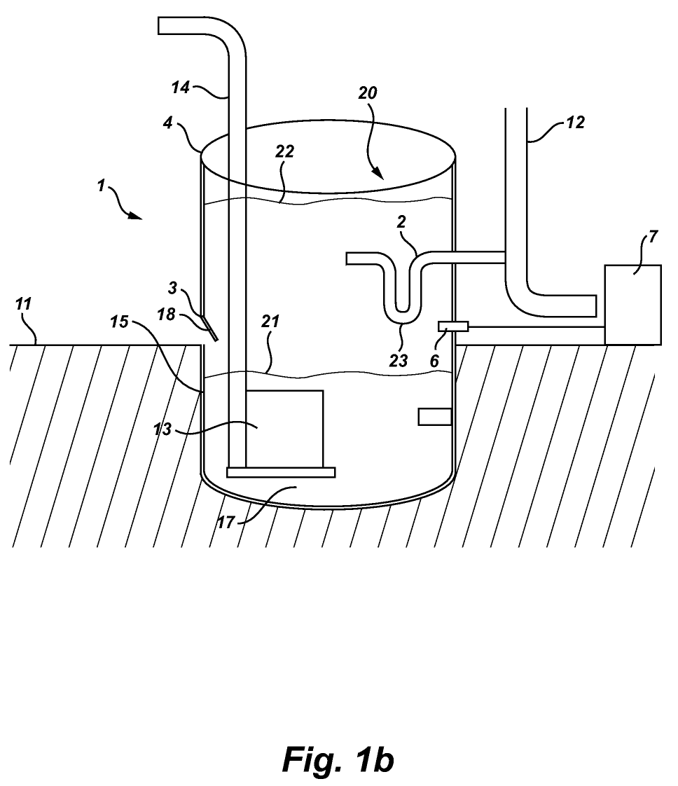

Referring to FIG. 1a, an open-topped flood-prevention sump well extension 1 is shown. A cylindrical wall 3 effectively extends the height of a sump sidewall 15 of a sump well 17 from a floor level 11 to a distal rim 4. A means for draining 20 is provided to prevent overflow of the distal rim 4. In the preferred embodiment, the means for draining 20 comprises an opening 9 in the cylindrical wall 3 for receiving a pipe 5. The pipe 5 is connected to a sewer or septic drain 12 through a one-way valve 8. As seen in FIG. 1a, the distal rim 4 is above the level of the discharge of pipe 5 to the sewer or septic drain 12. The one-way valve 8 prevents flow of sewer gases and raw sewage from the sewer or septic drain 12 to the open-topped flood-prevention sump well extension 1.

Referring to FIG. 1a, water flows from around the house foundation to at least one inlet drain 16, which empties into sump well 17. Normal operation of a sump pump 13 occurs when a normal water level 21 is reached. The sump pump 13 automatically activates to reduce the water from the normal water level 21 to below the level of sump pump 13. During this normal operation, the water is pumped through a sump drain pipe 14 to the outside of the building. If the sump pump 13 fails due to loss of power or mechanical failure, the water may rise to a malfunction water level 22. In this case, the water column will provide sufficient water pressure at the one-way valve 8 to overcome and open a spring biased closure 10 in the one-way valve 8. The opening of the spring biased closure 10 will permit the water to flow through the one-way valve 8 and toward the sewer or septic drain 12. Because the distal rim 4 is above the discharge to the sewer or septic drain 12, and because flow of fluid from the cylindrical wall 3 to the sewer or septic drain 12 is by force of gravity, spillover is thereby prevented. When the water level drops below the level of the one-way valve 8, the one-way valve 8 will close due to spring biased closure 10.

In the preferred embodiment, the excessive water in the cylindrical wall 3 will cause a water sensor 6 to electrically switch and activate an alarm 7. The water sensor 6 can be of any type known in the art such as ultrasonic, capacitive or other. The alarm 7 can be an audio, visual or wireless communication device which alerts the homeowner to the malfunction of the sump pump 13.

In addition, a flapper valve 18 may be attached to the interior of the cylindrical wall 3 to drain water seepage outside of the cylindrical wall 3 into sump well 17. If the water inside rises to a level at or above the flapper valve 18, the flapper valve 18 will be forcefully sealed against the cylindrical wall 3 and no water will flow from the open-topped flood-prevention sump well extension 1 to the floor level 11. If, however, water collects at the floor level 11, and the normal water level 21 is maintained, then the flapper valve 18 will open and the water will flow into the sump well 17. Alternatively, water may flow from floor level 11 to sump well 17 by means of a French drain (not shown) familiar to practitioners of the art.

Referring now to FIG. 1b the second embodiment of the present invention is shown. The one-way valve 8 (from FIG. 1a) can be replaced with a trap 2. The trap 2 prevents flow of sewer gases from the sewer or septic drain 12 by means of standing water 23 to the open-topped flood-prevention sump well extension 1.

The open top feature facilitates inspection of the pump and sump. Since the vessel is not pressurized, the gasketing at the floor and at the pipe opening can be simplified. Inexpensive construction materials are envisioned. For example, a plastic tub with the bottom cut-out could suffice for the cylindrical wall. The pipe need not be more than PVC plumbing pipe.

It is to be understood that the invention is not limited in its application to the details of construction and to the arrangements of the components set forth in the preceding description or illustrated in the drawings. The invention is capable of other embodiments and of being practiced and a carried out in various ways. Also, it is to be understood that the phraseology and terminology employed herein are for the purpose of the description and should not be regarded as limiting.

I claim:

1. An open-topped flood-prevention sump well extension for a house, comprising:
a cylindrical wall effectively extending the sump sidewall from a floor level to a level of the house sewer or septic drain, the cylindrical wall having a distal rim;
a means for draining water that backs up in the sump into the sewer or septic drain, the means operating by gravity alone to maintain the water level below the distal rim; and
a means for preventing sewer discharge from backing into the sump, whereby the systems for draining and preventing backing operate without the need of attendance or control by a person.

2. The open-topped flood-prevention sump well extension of claim 1, wherein the means for draining comprises a means for maintaining fluid communication between the sewer or septic drain and the sump.

3. The open-topped flood-prevention sump well extension of claim 2, wherein the means for maintaining fluid communication is an opening in the cylindrical wall for receiving a pipe and a pipe, no part of which elevates above the rim, extending from the opening to the sewer or septic drain.

4. The open-topped flood-prevention sump well extension of claim 1, wherein the means for preventing sewer discharge is an appropriately biased one-way valve in the pipe.

5. The open-topped flood-prevention sump well extension of claim 1, wherein the means for preventing sewer discharge is a pipe trap of U-shaped configuration.

6. The open-topped flood-prevention sump well extension of claim 1 further comprising an alarm to signal rising water level within the cylindrical wall.

7. An open-topped flood-prevention sump well extension for a house, comprising:
a cylindrical wall effectively extending the sump sidewall from a floor level to a level of the house sewer or septic drain, the cylindrical wall having a distal rim and an opening for receiving a pipe;
a pipe extending from the opening to the sewer or septic drain, wherein the sewer or septic drain is in fluid communication with the sump and no part of the pipe is above the rim; and
a means for preventing sewer discharge from backing into the sump, whereby the systems for draining and preventing backing operate without the need of attendance or control by a person.

8. The open-topped flood-prevention sump well extension of claim 7, wherein the means for preventing sewer discharge is an appropriately biased one-way valve in the pipe.

9. The open-topped flood-prevention sump well extension of claim 7, wherein the means for preventing sewer discharge is a pipe trap of U-shaped configuration.

10. The open-topped flood-prevention sump well extension of claim 7, further comprising an alarm to signal rising water level within the cylindrical wall.
